(19) United States
(12) Patent Application Publication
(10) Pub. No.: US 2023/0029566 A1
(43) Pub. Date: Feb. 2, 2023

(54) METHOD AND SYSTEM FOR DETECTING UNMANNED AERIAL VEHICLE USING PLURALITY OF IMAGE SENSORS

(71) Applicant: Electronics and Telecommunications Research Institute, Daejeon (KR)

(72) Inventors: Young-il KIM, Daejeon (KR); Seong Hee PARK, Daejeon (KR); Soonyong SONG, Daejeon (KR); Geon Min YEO, Daejeon (KR); Il Woo LEE, Daejeon (KR); Wun-Cheol JEONG, Daejeon (KR); Tae-Wook HEO, Daejeon (KR)

(73) Assignee: Electronics and Telecommunications Research Institute, Daejeon (KR)

(21) Appl. No.: 17/873,684

(22) Filed: Jul. 26, 2022

(30) Foreign Application Priority Data
Jul. 27, 2021 (KR) 10-2021-0098654
Jun. 13, 2022 (KR) 10-2022-0071265

(51) Int. Cl. G06T 7/292; G06T 7/70

(52) U.S. Cl. CPC G06T 7/292; G06T 7/70; G06T 2207/30232; G06T 2200/28; G06T 2207/30248

(57) ABSTRACT

Provided are a method and system for detecting a UAV using a plurality of image sensors. A method of detecting a UAV includes detecting, by each of a plurality of detection image sensors, a UAV in a UAV detection area, transmitting, when the UAV is detected, position information of the detection image sensor detecting the UAV and distance information of the UAV to a classification image sensor, acquiring, by the classification image sensor, a magnified image of the UAV by setting a parameter of a camera of the classification image sensor according to the position information and the distance information, and classifying a type of the UAV by analyzing the magnified image.

### CROSS-REFERENCE TO RELATED APPLICATIONS

This application claims the benefit of Korean Patent Application No. 10-2021-0098654 filed on Jul. 27, 2021, and Korean Patent Application No. 10-2022-0071265 filed on Jun. 13, 2022, in the Korean Intellectual Property Office, the entire disclosure of which are incorporated herein by reference for all purposes.

### BACKGROUND

### 1. Field of the Invention

One or more example embodiments relate to a method and system for detecting an unmanned aerial vehicle (UAV), and more particularly to a method and system for detecting a UAV by linking a plurality of image sensors.

### 2. Description of the Related Art

Recently, social unrest is heightening due to incidents of small unmanned aerial vehicles (UAVs) invading airports, public places, and protected areas. In particular, various technologies are being applied to protect human life and property from attacks through small UAVs used for military purposes.

Among UAV detection systems according to a related art, a UAV detection system using a low-resolution wide-angle camera has a larger area for detecting the UAV compared to a UAV detection system using a high-resolution telephoto camera, but there was a limitation in that a detection distance for detecting the UAV was short and the types of UAVs could not be classified due to lack of resolution with images shot by the low-resolution wide-angle camera.

On the other hand, the UAV detection system using the high-resolution telephoto camera has a longer detection distance to detect the UAV compared to the UAV detection system using the low-resolution wide-angle camera, and may classify the types of UAVs, but there was a limitation that the area in which the UAV could be detected was narrow.

Accordingly, there is a demand for a method of detecting the UAV capable of identifying the type of the UAV while having a wide area for detecting the UAV.

### SUMMARY

Example embodiments provide a method and system for detecting a UAV with a small number of image sensors compared to the UAV detection systems according to the related art and classifying the detected UAV by dividing image sensors into a detection image sensor for detecting the UAV and a classification image sensor for classifying the UAV.

Example embodiments provide a method and system for easily sharing position information for cooperation between a plurality of image sensors by installing a reference flag in a UAV prohibited area and calibrating the detection image sensor and the classification image sensor based on the reference flag.

According to an aspect, there is provided a method of detecting a UAV including detecting, by each of a plurality of detection image sensors, a UAV in a UAV detection area, transmitting, when the UAV is detected, position information of the detection image sensor detecting the UAV and distance information of the UAV to a classification image sensor, acquiring, by the classification image sensor, a magnified image of the UAV by setting a parameter of a camera of the classification image sensor according to the position information and the distance information and classifying a type of the UAV by analyzing the magnified image.

The detecting of the UAV may include shooting, by each of the plurality of detection image sensors, an image of the UAV detection area allocated to each of the plurality of detection image sensors, analyzing the image shot by each of the plurality of detection image sensors to determine whether the UAV is included in the shot image, and when the UAV is included in the shot image, determining that the UAV is detected within the UAV detection area by the detection image sensor shooting the image in which the UAV is included, and identifying a distance between the UAV and the detection image sensor.

The transmitting of the distance information may include transmitting, by the detection image sensor shooting the image in which the UAV is included, a call signal for calling the classification image sensor, receiving, by the detection image sensor shooting the image in which the UAV is included, a response from at least one classification image sensor positioned within a predetermined distance, and transmitting, by the detection image sensor shooting the image in which the UAV is included, the position information of the detection image sensor shooting the image in which the UAV is included and the distance between the UAV and the detection image sensor to a classification image sensor that first transmits the response.

The acquiring of the magnified image of the UAV may include determining, by the classification image sensor, an angle parameter of the camera of the classification image sensor according to the position information, and determining a magnification parameter of the camera of the classification image sensor according to the distance information, controlling, by the classification image sensor, an angle of the camera of the classification image sensor according to the angle parameter and controlling a zoom of the camera of the classification image sensor according to the magnification parameter, and shooting, by the classification image sensor, the magnified image of the UAV using the camera.

The method may further include, when the type of the UAV is unable be classified by analyzing the magnified image, re-shooting a magnified image by correcting the parameter of the camera of the classification image sensor, and the classifying may include classifying the type of the UAV by analyzing the re-shot magnified image.

According to another aspect, there is provided a system for detecting a UAV including a plurality of detection image sensors disposed at front of a UAV prohibited area to detect a UAV entering the UAV prohibited area, and a classification image sensor disposed at rear of the UAV prohibited area and configured to classify a type of the UAV, when at least one of the plurality of detection image sensors detects the UAV, by acquiring an magnified image of the UAV according to position information of the detection image sensor that detects the UAV and distance information of the UAV.

The plurality of detection image sensors may be configured to perform position calibration to match detection direction of the UAV based on the classification image sensor and a reference flag installed in the UAV prohibited area.

Each of the plurality of detection image sensors may be configured to set an initial value of position calibration by controlling a panning tilting (PT) of the detection image sensor so that the reference flag is displayed in the center of the camera screen of the detection image sensor.

The classification image sensor may be configured to set an initial value of the position calibration by controlling a PT of the classification image sensor so that the reference flag is displayed in the center of the camera screen of the classification image sensor.

Each of the plurality of detection image sensors may be configured to determine a distance between the detection image sensor and the UAV by referring to the number of pixels indicating size information of the UAV included in an image shot by a camera of the detection image sensor and a camera lens magnification

Each of the plurality of detection image sensors may be configured to control a PT of the detection image sensor so that, when the UAV is detected, the detected UAV is positioned in a center of a camera screen of the detection image sensor.

The detection image sensor that detects the UAV may be configured to transmit a call signal to call the classification image sensor, and transmit, when a response is received from at least one classification image sensor positioned within a predetermined distance, the PT of the detection image sensor, the position information indicating a position where the detection image sensor is installed, and the distance information indicating a distance between the detection image sensor and the UAV to a classification image sensor that first transmit the response.

The classification image sensor may be configured to acquire the magnified image of the UAV by setting a parameter of a camera of the classification image sensor according to the position information and the distance information.

The classification image sensor may be configured to determine an angle parameter of the camera of the classification image sensor according to the position information, and control an angle of the camera of the classification image sensor according to the angle parameter, determine a magnification parameter of the camera of the classification image sensor according to the distance information, and control a zoom of the camera of the classification image sensor according to the magnification parameter, and shoot the magnified image of the UAV by using the camera of the classification image sensor whose angle and zoom are controlled.

The classification image sensor may be configured to, when the type of the UAV is unable be classified by analyzing the magnified image, re-shoot a magnified image by correcting a parameter of a camera of the classification image sensor, and classify the type of the UAV by analyzing the re-shot magnified image.

Additional aspects of example embodiments will be set forth in part in the description which follows and, in part, will be apparent from the description, or may be learned by practice of the disclosure.

According to example embodiments, it is possible to detect a UAV and classify the type of the UAV with a small number of image sensors compared to the UAV detection systems according to the related art by dividing the image sensors into the detection image sensor for detecting the UAV and the classification image sensor for classifying the UAV, and when the UAV is detected by the detection image sensor, adjusting the magnification of the camera of the classification image sensor according to a position of the detected UAV to take a magnified image of the UAV, and analyzing the magnified image to classify the type of the UAV.

According to example embodiments, it is possible to easily share position information (e.g., information on an installation position and a camera shooting direction) for cooperation between a plurality of image sensors by installing a reference flag in the UAV prohibited area and calibrating the detection image sensor and the classification image sensor based on the reference flag.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a UAV detection system according to an example embodiment;

FIG. 2 is a diagram illustrating an operation of a UAV detection system according to an example embodiment;

FIG. 3 is a diagram illustrating an example of an image sensor of a UAV detection system according to an example embodiment;

FIG. 4 is a diagram illustrating an example of an image sensor arrangement of a UAV detection system according to an example embodiment;

FIG. 5 is a schematic diagram illustrating panning angle calibration between image sensors of a UAV detection system according to an example embodiment;

FIG. 6 is a schematic diagram of tilt angle calibration between image sensors of a UAV detection system according to an example embodiment;

FIG. 7 is a schematic diagram illustrating tilting control of a UAV detection system according to an example embodiment;

FIG. 8 is a diagram illustrating a method of detecting a UAV according to an example embodiment;

FIG. 9 is a flowchart illustrating a method of calibrating an image sensor according to an example embodiment;

FIG. 10 is a flowchart illustrating a method of operating a detection image sensor of a UAV detection system according to an example embodiment; and

FIG. 11 is a flowchart illustrating a method of operating a classification image sensor of a UAV detection system according to an example embodiment.

### DETAILED DESCRIPTION

Hereinafter, example embodiments will be described in detail with reference to the accompanying drawings. A UAV detection method according to an example embodiment may be performed by a UAV detection system.

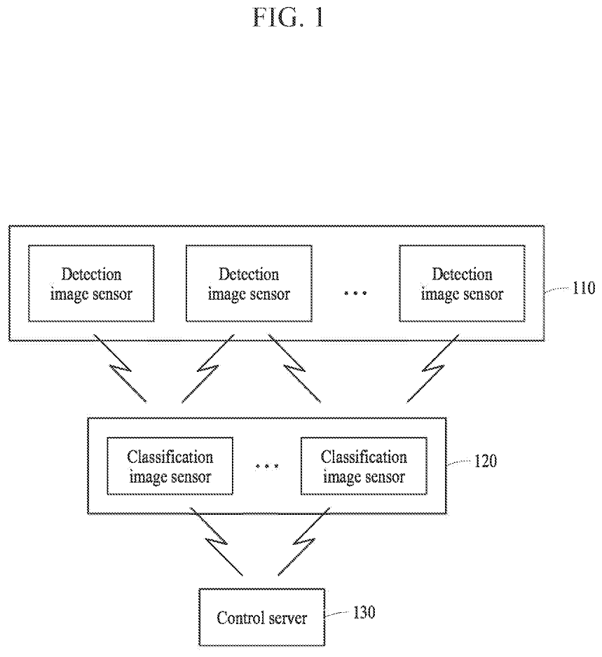

FIG. 1 is a diagram illustrating a UAV detection system according to an example embodiment.

As shown in FIG. 1, the UAV detection system may include a plurality of detection image sensors 110, a plurality of classification image sensors 120, and a control server 130.

The detection image sensors 110 may be disposed at front of a UAV prohibited area to detect a UAV entering the UAV prohibited area. At this time, the detection image sensors 110 may determine a distance between the detection image sensor 110 and the UAV with reference to the number of pixels indicating the size of the UAV included in an image shot by a camera of the detection image sensor 110 and a camera lens magnification. In addition, the camera of the detection image sensor 100 may be a wide-angle camera having a resolution capable of identifying whether or not the UAV exists.

The classification image sensors 120 may be disposed at the rear of the UAV prohibited area. In addition, when at least one of the detection image sensors 110 detects the UAV, one of the classification image sensors 120 positioned within a predetermined distance from the detection image sensor 110 that detects the UAV may receive the position information of the detection image sensor 110 and the distance information of the UAV. In addition, the classification image sensor 120 that receives the position information of the detection image sensor 110 that detects the UAV and the distance information of the UAV may classify the type of the UAV by acquiring magnified images according to the received position information of the detection image sensor 110 and the distance information of the UAV. In addition, a camera of the classification image sensor 120 may be a telephoto camera capable of changing the magnification to a resolution capable of identifying the type of the UAV.

The detection image sensors 110 may perform position calibration to match detection direction of the UAV based on the classification image sensor 120 and a reference flag installed in the UAV prohibited area. Also, the classification image sensor 120 may perform position calibration based on the detection image sensors 110 and the reference flag.

In this case, each of the detection image sensors 110 may set an initial value of the position calibration by controlling the PT of the detection image sensor 110 so that the reference flag is displayed in the center of the camera screen of the detection image sensor 110. Also, each of the classification image sensors 120 may set the initial value of the position calibration by controlling the PT of the classification image sensor 120 so that the reference flag is displayed in the center of the camera screen of the classification image sensor 120.

In addition, when each of the detection image sensors 110 detects the UAV, each of the detection image sensors 110 may control the PT of the detection image sensor 110 so that the detected UAV is positioned in the center of the camera screen of the detection image sensor 110.

In addition, the detection image sensor 110 that detects the UAV may transmit a call signal for calling the classification image sensor 120. When a response to the call signal is received from at least one classification image sensor 120 positioned within a predetermined distance, the detection image sensor 110 that detects the UAV may transmit the PT of the detection image sensor 110, position information indicating a position where the detection image sensor 110 is installed, and distance information indicating a distance between the detection image sensor 110 and the UAV to the classification image sensor 120 that first transmits the response.

In addition, the classification image sensor 120 may acquire an magnified image of the UAV by setting parameters of the camera of the classification image sensor 120 according to the position information and distance information received from the detection image sensor 110. In this case, the classification image sensor 120 may determine an angle parameter of the camera of the classification image sensor 120 according to the received position information, and may control the angle of the camera of the classification image sensor 120 according to the angle parameter. Also, the classification image sensor 120 may determine a magnification parameter of the camera of the classification image sensor 120 according to the received distance information, and control the zoom of the camera of the classification image sensor 120 according to the magnification parameter. In addition, the classification image sensor 120 may shoot a magnified image of the UAV using the camera of the classification image sensor 120 whose the angle and the zoom are controlled.

In addition, when the type of the UAV cannot be classified by analyzing the magnified image, the classification image sensor 120 may correct the parameters of the camera of the classification image sensor 120 to re-shoot a magnified image, and classify the type of the UAV by analyzing the re-shot magnified image.

The control server 130 may manage position information and initial values of the position calibration of each of the detection image sensors 110 and the classification image sensors 120. Also, the classification image sensor 120 may transmit the received position information and the classified type of the UAV to the control server 130. In this case, the control server 130 may identify the position of the UAV according to the position information, and map the position with the type of the UAV classified by the classification image sensor 120 to provide the position mapped with the type to the user.

The UAV detection system according to an example embodiment may detect the UAV using the detection image sensors 110, shoot the magnified image of the UAV by adjusting the magnification of the camera of the classification image sensor 120 according to the position of the detected UAV when the UAV is detected by the detection image sensor 110, detect the UAV and classify the type of the detected UAV by analyzing the magnified image and classifying the type of the UAV with fewer image sensor compared to the UAV detection systems according to the related art.

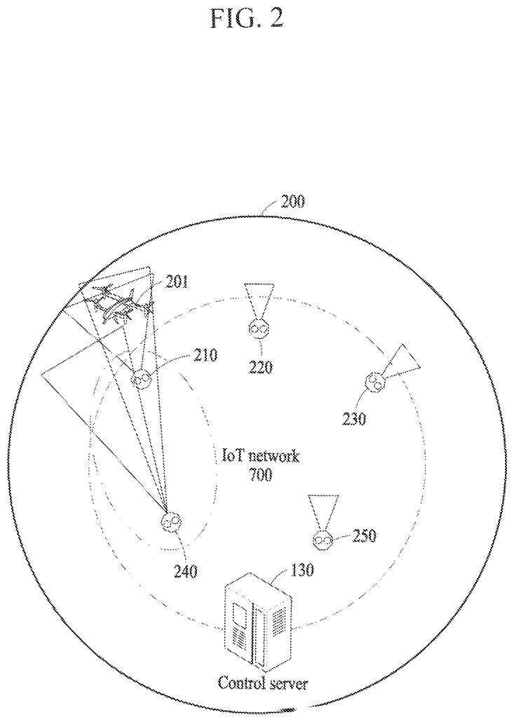

FIG. 2 is a diagram illustrating an operation of a UAV detection system according to an example embodiment.

The UAV detection system may arrange a plurality of image sensors 210, 220, 230, 240 and 250 in a UAV prohibited area 200 as shown in FIG. 2. In this case, each of the image sensors 210, 220, 230, 240, and 250 may be configured with a camera and a graphics processing unit (GPU) device performing an image deep learning algorithm. In addition, the control server 130 may control and manage the image sensors. In this case, each of the image sensors and the control server 130 may interact with each other through an internet of things (IoT) network 700.

In addition, each of the image sensors may detect or classify a UAV 201 that enters the UAV prohibited area 200 through a deep learning algorithm (e.g., Yolo, ResNet, RE3 and the like) analysis of the camera image.

At this time, the image sensors 210, 220 and 230 disposed at the front of the UAV prohibited area 200 are detection image sensors 110, and the image sensors 240 and 250 disposed at the rear of the UAV prohibited area 200 are classification image sensors 120. In addition, the UAV detection system according to an example embodiment may detect the presence of the UAV 201 using the detection image sensor 110 including a low-resolution wide-angle camera, and shoot the magnified image of the UAV 201 to classify the type of the UAV 201 using the classification image sensor 120 including a high-resolution telephoto camera.

For example, the image sensor 210 that is the detection image sensor 110 may detect the UAV 201 through deep learning on an object included in the image shot by the wide-angle camera. In this case, the size of the object included in the image shot by the wide-angle camera may be 20*20 pixels.

In addition, the image sensor 210 may transmit position information of the image sensor 210 and distance information of the UAV to the image sensor 240 that is the classification image sensor 120.

The image sensor 240 may identify the position of the UAV 201 according to the received position information and distance information, and control the position and magnification of the camera according to the position of the UAV 201 (e.g., panning tilting zooming) to shoot the magnified image of the UAV 201. For example, the size of the UAV 201 included in the magnified image shot by the image sensor 240 may be 80*80 pixels.

In other words, since the magnified image shot by the image sensor 240 includes the UAV 201 as an object of a size capable of classifying types, the image sensor 240 may classify the type of the UAV 201 by comparing the object included in the magnified image with the previously learned UAV data set.

In summary, the UAV detection system according to an example embodiment may divide the image sensors into the image sensors 210, 220 and 230 which are the detection image sensors 110 and the image sensors 240 and 250 which are the classification image sensors 120, and may operate the image sensors. At this time, since the image sensors 210, 220 and 230 which are the detection image sensors 110 are capable of detecting the UAV 201 even with a wide-angle (e.g., 70 degree) screen, each of the image sensors may expand a monitoring area of the intrusion of the UAV 201. In addition, since the image sensors 240 and 250 that are the classification image sensor 120 can perform a classification function by adjusting the direction and lens magnification of the camera to the position requested by the detection image sensor 110, classification accuracy may increase and the number of cameras required to classify the types of the UAV 201 may be reduced.

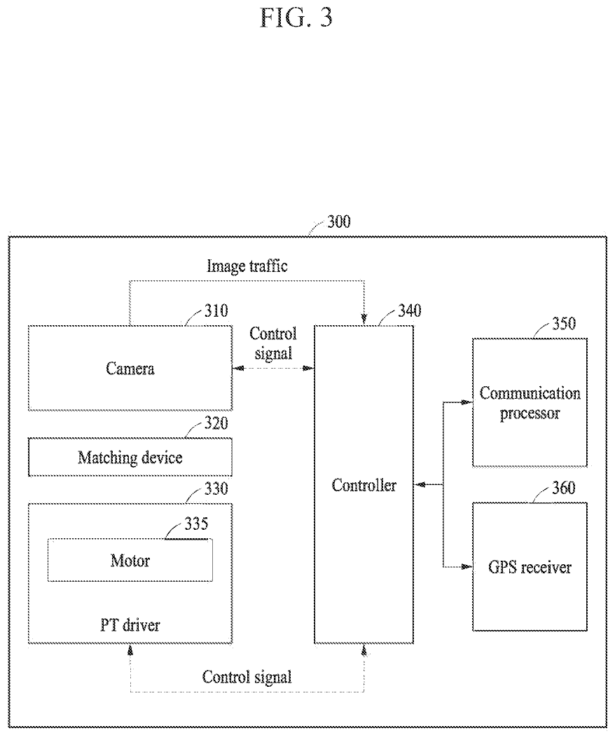

FIG. 3 is an example of an image sensor of a UAV detection system according to an example embodiment.

An image sensor 300 may include a camera 310, a matching device 320, a PT driver 330, a controller 340, a communication processor 350, and a global positioning system (GPS) receiver 360 as shown in FIG. 3.

When the image sensor 300 is the detection image sensor 110, the camera 310 may be a wide-angle camera. Also, when the image sensor 300 is the classification image sensor 120, the camera 310 may be a telephoto camera.

The matching device 320 may be a matching device between the camera 310 and the PT driver 330.

The PT driver 330 may include a motor 140 that controls a horizontal direction and a vertical direction of the camera 310.

The controller 340 may control the camera 310 using the PT driver 330. Specifically, the controller 340 may control the horizontal direction and the vertical direction of the camera 310 by controlling the rotation direction and speed of the motor 140 according to the control signal transmitted to the PT driver 330.

The communication processor 350 may perform a communication function between the image sensor 300 and another image sensor or the control server. For example, when the image sensor 300 is the detection image sensor 110, a communication processor 160 may transmit the position information of the image sensor 300 and distance information of the UAV to the classification image sensor 120. Also, when the image sensor 300 is the classification image sensor 120, the position information of the detection image sensor 110 and distance information of the UAV may be received from the detection image sensor 110.

The GPS receiver 360 may acquire installation position information of the image sensor 300. Also, according to an example embodiment, a GPS receiver 170 may be replaced with a storage medium in which information on the installation position of the image sensor 300 is stored.

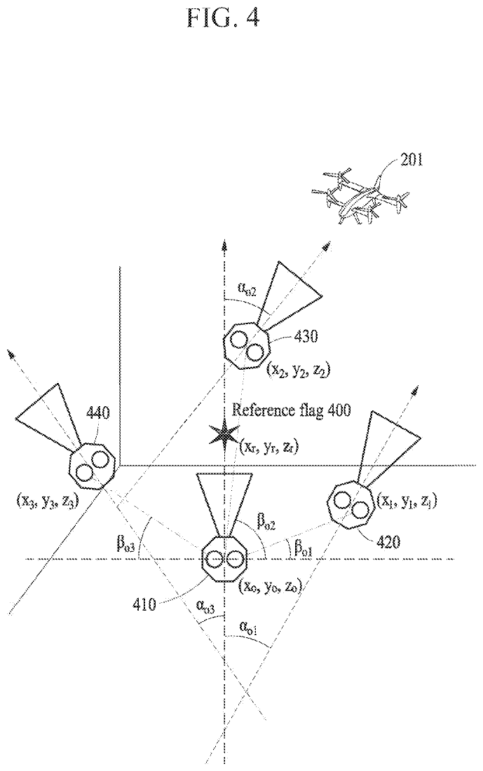

FIG. 4 is an example of an image sensor arrangement of a UAV detection system according to an example embodiment.

The UAV detection system according to an example embodiment may install image sensors 410, 420, 430 and 440 in the UAV prohibited area. At this time, for cooperation between the image sensors 410, 420, 430 and 440, the position information viewed by lens of each of the image sensors 410, 420, 430 and 440 as well as the installation position information between the image sensors 410, 420, 430 and 440 should be shared.

Therefore, the UAV detection system may share position information (e.g., latitude x, longitude y, altitude z) by mounting the GPS receiver on each of the image sensors, and calibrate the positions of the cameras of each of the image sensors based on a reference flag 400.

FIG. 4 is an example of a UAV detection system including an origin image sensor 410 that is a classification image sensor 120, an image sensor #1 420, an image sensor #2 430, and an image sensor #3 440 that are a detection image sensor 110. In other words, the image sensor #1 420, the image sensor #2 430, and the image sensor #3 440 may detect the UAV 201, and the origin image sensor 410 may classify the type of the UAV 201 by shooting the UAV 201 using the camera magnified by zoom-in.

At this time, each of the image sensors 410, 420, 430 and 440 may perform initialization position calibration to match the detection direction of the UAV 201 after matching the reference flag 400 with the center point of the front of the camera screen.

As shown in FIG. 4, when the reference flag 400 and the origin image sensor 410 are on the same line, the azimuth angles formed by each of the origin image sensor 410, the image sensor #1 420, the image sensor #2 430, and the image sensors #3 440 may be αₒ₁, αₒ₂ and αₒ₃, and the elevation angles may be βₒ₁, βₒ₂ and βₒ₃. At this time, each of the image sensors 410, 420, 430 and 440 may share information on the azimuth angles and the elevation angles and control the PTZ so that the UAV 201 can be positioned on the camera of each of the image sensors 410, 420, 430 and 440.

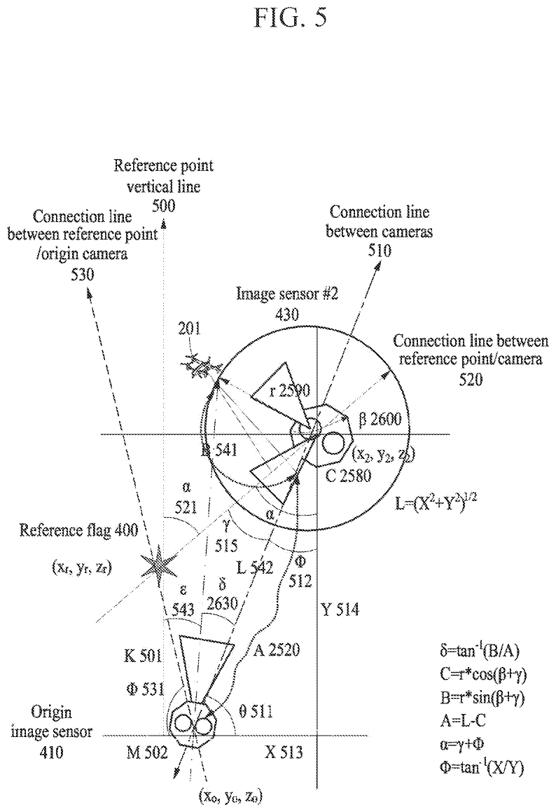

FIG. 5 is a calibration concept diagram of a panning angle between image sensors in a process in which the origin image sensor 410 and the image sensor #2 430 cooperate to detect and classify the UAV 201 in the UAV detection system according to an example embodiment.

First, the origin image sensor 410 may control the PT value of the origin image sensor 410 so that the reference flag 400 appears in the center of the camera screen and set the PT value as an initial value.

In addition, the image sensor #2 430 may also control the PT value of the image sensor #2 430 so that the reference flag 400 appears in the center of the camera screen and set the PT value as an initial value.

In this case, the angle formed by the origin image sensor 410 and the reference flag 400 may be ϕ 531 based on a reference point vertical line 500 and a connection line 530 between reference point and the camera of the origin image sensor 410. Also, the angle formed by the image sensor #2 430 and the reference flag 400 may be α 521 based on the reference point vertical line 500.

Further, the vertical distance between the origin image sensor 410 and the reference flag 400 may be K 501 and the horizontal distance may be M 502 based on the vertical line 500. In addition, the angle formed by the origin image sensor 410 and the image sensor #2 430 are θ 511 and φ 512, respectively, and the horizontal distance between the origin image sensor 410 and the image sensor #2 430 may be X 513, and the vertical distance may be Y 514. In addition, the angle formed by the reference flag 400, the origin image sensor 410 and the image sensor #2 430 based on the connection line 510 between cameras may be γ 515.

When the image sensor #2 430 detects the UAV 201 that moves by the angle β 2600 from the initial origin position of the PTZ to be located at a distance r from the image sensor #2 430, the length of the vertical line connecting the camera connection line 510 and the UAV 201 may be B 541, and the length from the end point of the vertical line connecting the camera connection line 510 and the UAV 201 to the origin image sensor 410 may be A 2520. In addition, the distance from the image sensor #2 430 to the origin image sensor 410 may be L 542, the distance from the origin position (x2, y2, z2) of the image sensor #2 430 to the end point of the vertical line connecting the camera connection line 510 and the UAV 201 may be C 2580, and the angle between the connection line 510 between the cameras and the straight line from the UAV 201 to the origin image sensor 410 may be δ 2630.

For example, the origin image sensor 410 may determine ε 543 according to Equation 1. In addition, the origin image sensor 410 may shoot the image of the UAV 201 by rotating the camera by ε 543 from the reference flag 400 and the set initial value.

$$L = {( {( {x}_{2} - {x}_{a} )}^{2} + {( {y}_{2} - {y}_{a} )}^{2} )}^{\frac{1}{2}} \\ C = r * cos ( β + γ ) \\ B = r * sin ( β + γ ) \\ A = L - C \\ α = γ + ϕ \\ ϕ = {tan}^{- 1} ( X / Y ) \\ φ = {tan}^{- 1} ( K / L ) \\ θ = {tan}^{- 1} ( Y / X ) \\ δ = {tan}^{- 1} ( B / A ) \\ ε = π - ( φ + θ + δ ) \qquad [ Equation 1 ]$$

At this time, the image sensor #2 430 may estimate the distance r 2590 between the image sensor #2 430 and the UAV 201 by comparing the size of the image screen generated by the camera of the image sensor #2 430 by shooting the UAV with the size of the UAV object included in the image screen. Also, the image sensor #2 430 may estimate the distance r 2590 between the image sensor #2 430 and the UAV 201 using the stereo image sensor. Further, the image sensor #2 430 may estimate the distance r 2590 between the image sensor #2 430 and the UAV 201 using Equation 2 based on information on the “distance (Df) from a camera lens to an image pickup surface” obtained during the camera calibration process.

$$\frac{1}{Df} + \frac{1}{D} = \frac{1}{F} \\ \frac{Df}{D} = \frac{u}{U} \qquad [ Equation 2 ]$$

In this case, F may be a focal length of the camera, and D may be a distance between the camera and the UAV 201. Also, U may be the size of the UAV 201, and u may be the size of the UAV object included in the image screen shot by the camera.

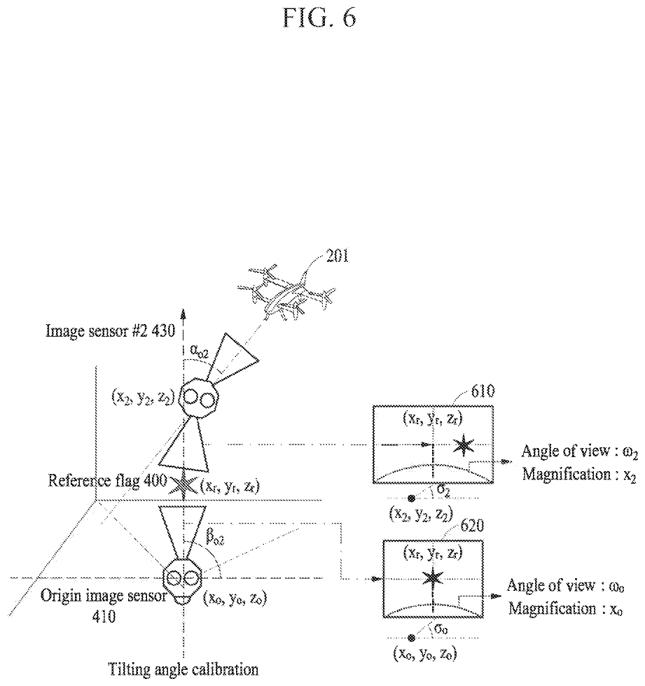

FIG. 6 is a schematic diagram of a tilt angle calibration between image sensors of a UAV detection system according to an example embodiment.

The origin image sensor 410 may control tilting, zooming (TZ) value of the origin image sensor 410 so that the flag object positioned in the reference flag 400 may be positioned in the center point of the camera image screen 620 of the origin image sensor 410. In addition, the image sensor #2 430 may control the TZ value of the image sensor #2 430 so that the flag object positioned in the reference flag 400 may be positioned in the center point of the camera image screen 610 of the image sensor #2 430. For example, although the flag object has the shape of an asterisk in FIG. 6, various shapes may be used as the flag object according to an example embodiment.

In other words, the origin image sensor 410 and the image sensor #2 430 may convert the tilting value and zooming value of the camera so that the flag object is positioned in the center of the screen, and obtain a value Df that is the distance from the camera lens to the image pickup surface by writing the size of the flag (e.g., bounding box) displayed on the screen as table.

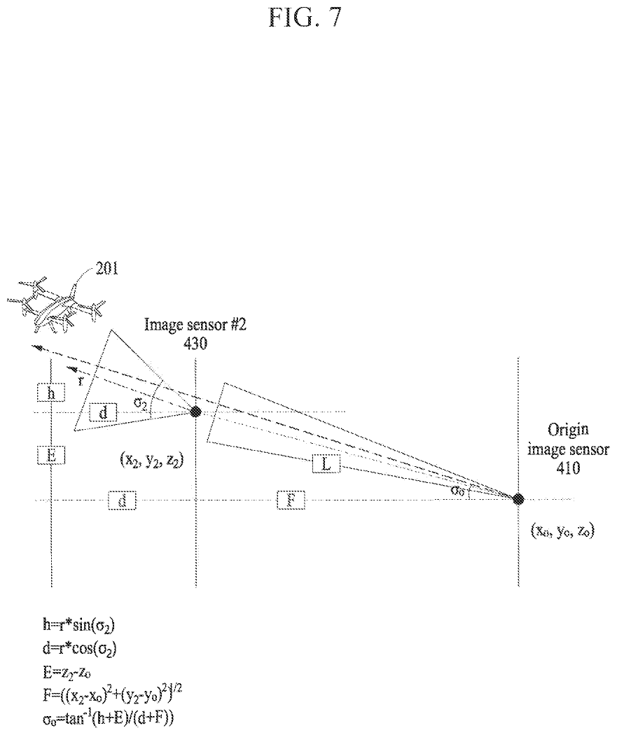

FIG. 7 is a tilting control schematic diagram of a UAV detection system according to an example embodiment.

As shown in FIG. 7, when the image sensor #2 430 detects the UAV 201 positioned at a distance r, the image sensor #2 430 may control the PTZ to move the UAV 201 to the center of the screen. Next, the image sensor #2 430 may transmit related information such as the distance r, the tilting angle, and the coordinates of the installation position of the image sensor #2 430 to the origin image sensor 410.

In this case, the origin image sensor 410 may control the PTZ value to the altitude position of the UAV detected by the image sensor #2 430 using the relationship of the trigonometric equation as shown in FIG. 7. Then, after the origin image sensor 410 controls the PTZ value, the origin image sensor 410 may shoot the UAV 201 with the camera to obtain the magnified image of the UAV 201, and perform an image deep learning algorithm on the magnified image of the UAV 201 to classify the type of the UAV 201.

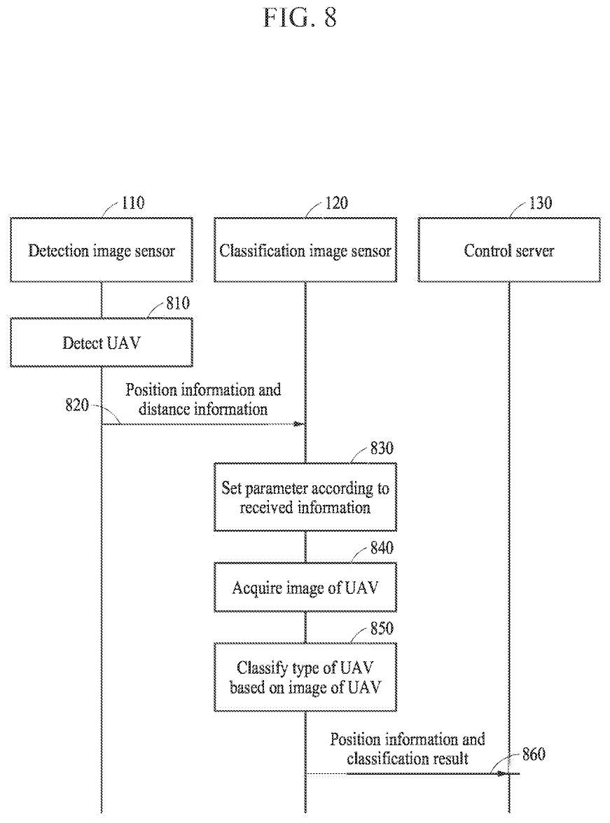

FIG. 8 is a diagram illustrating a method of detecting a UAV according to an example embodiment.

In operation 810, the detection image sensors 110 may detect the UAV entering the UAV prohibited area. In this case, the detection image sensors 110 may determine the distance between the detection image sensor 110 and the UAV with reference to the number of pixels indicating the size of the UAV included in the image shot by the camera of the detection image sensor 110 and the magnification of the camera lens. Also, the detection image sensor 110 may control the PT of the detection image sensor 110 so that the detected UAV is positioned in the center of the camera screen of the detection image sensor 110.

In operation 820, the detection image sensor 110 may transmit the PT of the detection image sensor 110, position information indicating the position where the detection image sensor 110 is installed, and the distance information indicating the distance between the detection image sensor 110 and the UAV to the classification image sensor 120.

In operation 830, the classification image sensor 120 may set parameters of the camera of the classification image sensor 120 according to the position information of the detection image sensor 110 and the distance information of the UAV received in operation 820.

In operation 840, the classification image sensor 120 may shoot the magnified image of the UAV using the camera of the classification image sensor 120 whose angle and zoom are controlled according to the parameters set in operation 830.

In operation 850, the classification image sensor 120 may classify the type of the UAV based on the magnified image of the UAV.

In operation 860, the classification image sensor 120 may transmit the position information received from the detection image sensor 110 and the type of the UAV classified by the classification image sensor 120 to the control server 130. In this case, the control server 130 may identify the position of the UAV according to the position information, map the position with the type of the UAV classified by the classification image sensor 120 and provide the position of the UAV to the user.

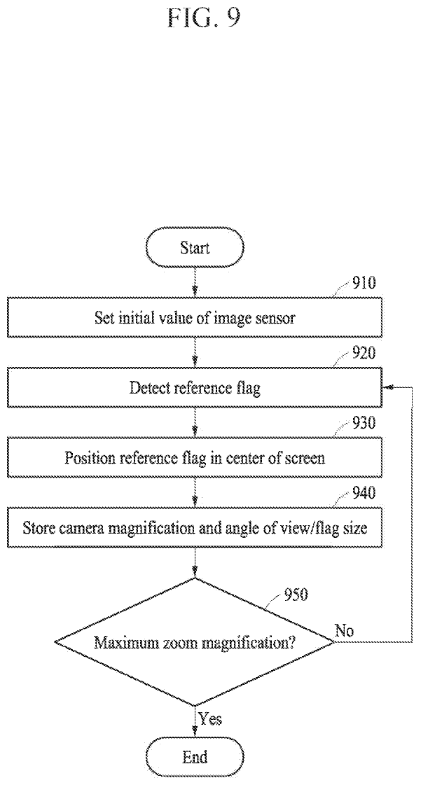

FIG. 9 is a flowchart illustrating a method of calibrating an image sensor according to an example embodiment.

In operation 910, each of the image sensors may set initial values. For example, the image sensor may be one of the detection image sensor 110 and the classification image sensor 120.

In operation 920, the image sensors may detect the reference flag from the image shot by a camera of each of the image sensors.

In operation 930, the image sensors may vary the PTZ value of the camera or image sensors so that the reference flag detected in operation 920 is positioned at the center of the camera screen.

In operation 940, the image sensors may generate a table for storing the camera focal length (e.g., magnification), the angle of view, and the flag size in the screen according to the PTZ value varied in operation 930.

In operation 950, the image sensors may check whether the current magnification of the camera is the maximum zoom magnification. When the current magnification of the camera is the maximum zoom magnification, the image sensors may end calibration. On the other hand, when the current magnification of the camera is not the maximum zoom magnification, the image sensors may perform operation 920 after increasing the magnification of the camera.

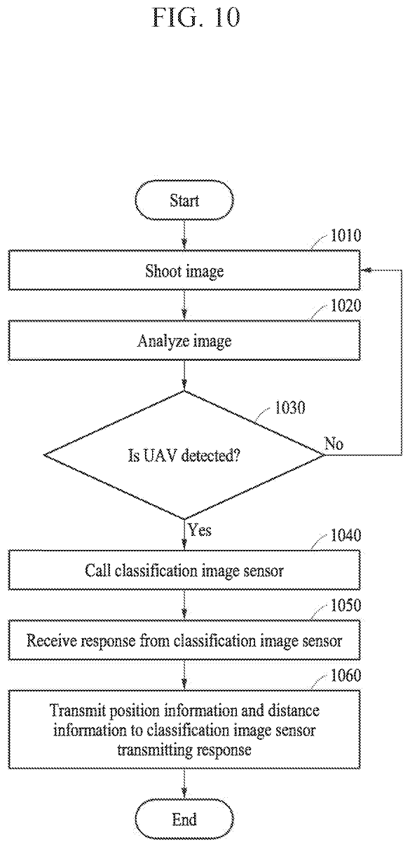

FIG. 10 is a flowchart illustrating a method of operating a detection image sensor of a UAV detection system according to an example embodiment.

In operation 1010, the detection image sensor 110 may generate the image by shooting the UAV detection area allocated to each of the detection image sensors 110 with the camera.

In operation 1020, the detection image sensor 110 may analyze the image shot in operation 1010. In this case, the detection image sensor 110 may determine whether the object included in the image is the UAV using image deep learning. When the UAV is detected, the detection image sensor 110 may determine the distance between the detection image sensor 110 and the UAV with reference to the number of pixel sizes of the UAV object included in the image shot in operation 1010 and the camera lens magnification. In addition, the detection image sensor 110 may control the PTs of the detection image sensors 110 so that the detected UAV is positioned in the center of the camera screen of the detection image sensor 110.

In operation 1030, the detection image sensor 110 may determine whether the UAV is detected from the analysis result of operation 1020. When the UAV is not detected, the detection image sensor 110 may repeatedly perform operation 1010 to operation 1030 until the UAV is detected. When the UAV is detected, the detection image sensor 110 may perform operation 1040.

In operation 1030, the detection image sensor 110 may transmit a call signal for calling the classification image sensor 120.

In operation 1040, the detection image sensor 110 may receive a response to the call signal from at least one classification image sensor 120 positioned within a predetermined distance.

In operation 1050, the detection image sensor 110 may transmit the PT of the detection image sensor 110, position information indicating the position where the detection image sensor 110 is installed, and the distance information indicating the distance between the detection image sensor 110 and the UAV to the classification image sensor 120 that transmits the response first.

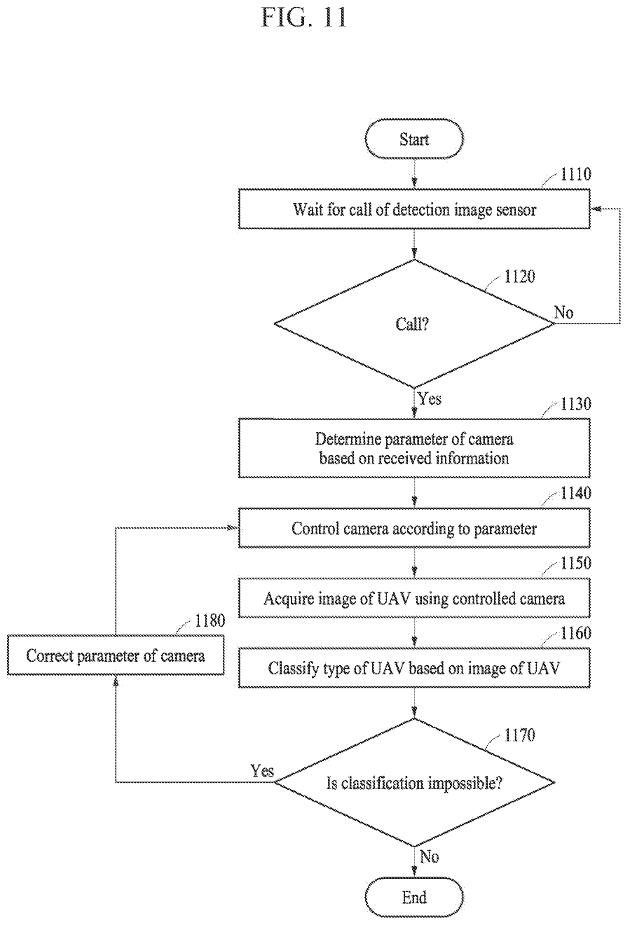

FIG. 11 is a flowchart illustrating a method of operating a classification image sensor of a UAV detection system according to an example embodiment.

In operation 1110, the classification image sensor 120 may wait for reception of a call signal.

In operation 1120, the classification image sensor 120 may determine whether the call signal has been received from the detection image sensor 110. When the call signal is received, the classification image sensor 120 may perform operation 1130. Also, when the call signal is not received, the classification image sensor 120 may repeatedly perform operation 1110 to operation 1120 until the call signal is received.

In operation 1130, the classification image sensor 120 may receive the position information of the detection image sensor 110 detecting the UAV and the distance information of the UAV. In addition, the classification image sensor 120 may set parameters of the camera of the classification image sensor 120 according to the position information and distance information received from the detection image sensor 110. In this case, the classification image sensor 120 may determine the angle parameter of the camera of the classification image sensor 120 according to the received position information, and determine the magnification parameter of the camera of the classification image sensor 120 according to the received distance information.

In operation 1140, the classification image sensor 120 may control the camera according to the parameter determined in operation 1130. Specifically, the classification image sensor 120 may control the angle of the camera of the classification image sensor 120 according to the angle parameter. Also, the classification image sensor 120 may control a zoom of the camera of the classification image sensor 120 according to a magnification parameter.

In operation 1150, the classification image sensor 120 may shoot the magnified image of the UAV using the camera of the classification image sensor 120 whose angle and zoom are controlled in operation 1140.

In operation 1160, the classification image sensor 120 may classify the type of the UAV by using the image deep learning on the magnified image of the UAV. In this case, the classification image sensor 120 may classify the type of the UAV according to the type of UAV object that has the highest similarity to the UAV object included in the magnified image through the pre-learned image deep learning model.

In operation 1170, the classification image sensor 120 may determine whether the classification of the UAV is impossible in operation 1160. For example, when the reliability of detection of the UAV through the deep learning is low, the classification image sensor 120 may determine that the type of the UAV cannot be classified.

When classification of the UAV is possible, the classification image sensor 120 may end the operation. On the other hand, when classification of the UAV is impossible, the classification image sensor 120 may perform operation 1180.

In operation 1180, the classification image sensor 120 may correct the camera parameters of the classification image sensor 120. Specifically, the classification image sensor 120 may increase a zoom magnification among parameters. Further, in operation 1140, the classification image sensor 120 may control the zoom function of the camera of the classification image sensor 120 according to the corrected parameter. Next, in operation 1150, the classification image sensor 120 may re-shoot the magnified image larger than the first according to the controlled zoom function of the camera. Next, in operation 1160, the classification image sensor 120 may classify the type of the UAV by analyzing the re-shot magnified image

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The methods according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of detecting an unmanned aerial vehicle (UAV), the method comprising:
detecting, by each of a plurality of detection image sensors, a UAV in a UAV detection area;
transmitting, when the UAV is detected, position information of the detection image sensor detecting the UAV and distance information of the UAV to a classification image sensor;
acquiring, by the classification image sensor, a magnified image of the UAV by setting a parameter of a camera of the classification image sensor according to the position information and the distance information; and
classifying a type of the UAV by analyzing the magnified image.

2. The method of claim 1, wherein the detecting of the UAV comprises:
shooting, by each of the plurality of detection image sensors, an image of the UAV detection area allocated to each of the plurality of detection image sensors;
analyzing the image shot by each of the plurality of detection image sensors to determine whether the UAV is included in the shot image; and
when the UAV is included in the shot image, determining that the UAV is detected within the UAV detection area by the detection image sensor shooting the image in which the UAV is included, and identifying a distance between the UAV and the detection image sensor.

3. The method of claim 2, wherein the transmitting of the distance information comprises:
transmitting, by the detection image sensor shooting the image in which the UAV is included, a call signal for calling the classification image sensor;
receiving, by the detection image sensor shooting the image in which the UAV is included, a response from at least one classification image sensor positioned within a predetermined distance; and
transmitting, by the detection image sensor shooting the image in which the UAV is included, the position information of the detection image sensor shooting the image in which the UAV is included and the distance between the UAV and the detection image sensor to a classification image sensor that first transmits the response.

4. The method of claim 1, wherein the acquiring of the magnified image of the UAV comprises:
determining, by the classification image sensor, an angle parameter of the camera of the classification image sensor according to the position information, and determining a magnification parameter of the camera of the classification image sensor according to the distance information;
controlling, by the classification image sensor, an angle of the camera of the classification image sensor according to the angle parameter, and controlling a zoom of the camera of the classification image sensor according to the magnification parameter; and
shooting, by the classification image sensor, the magnified image of the UAV using the camera.

5. The method of claim 1, further comprising:
when the type of the UAV is unable be classified by analyzing the magnified image, re-shooting a magnified image by correcting the parameter of the camera of the classification image sensor,
wherein the classifying comprises classifying the type of the UAV by analyzing the re-shot magnified image.

6. A system for detecting an unmanned aerial vehicle (UAV), the system comprising:
a plurality of detection image sensors disposed at front of a UAV prohibited area to detect a UAV entering the UAV prohibited area; and
a classification image sensor disposed at rear of the UAV prohibited area and configured to classify a type of the UAV, when at least one of the plurality of detection image sensors detects the UAV, by acquiring an magnified image of the UAV according to position information of the detection image sensor that detects the UAV and distance information of the UAV.

7. The system of claim 6, wherein the plurality of detection image sensors are configured to perform position calibration to match detection direction of the UAV based on the classification image sensor and a reference flag installed in the UAV prohibited area.

8. The system of claim 7, wherein each of the plurality of detection image sensors is configured to set an initial value of the position calibration by controlling a panning tilting (PT) of the detection image sensor so that the reference flag is displayed in a center of a camera screen of the detection image sensor.

9. The system of claim 7, wherein the classification image sensor is configured to set an initial value of the position calibration by controlling a PT of the classification image sensor so that the reference flag is displayed in a center of a camera screen of the classification image sensor.

10. The system of claim 6, wherein each of the plurality of detection image sensors is configured to determine a distance between the detection image sensor and the UAV by referring to the number of pixels indicating size information of the UAV included in an image shot by a camera of the detection image sensor and a camera lens magnification.

11. The system of claim 6, wherein each of the plurality of detection image sensors is configured to control a PT of the detection image sensor so that, when the UAV is detected, the detected UAV is positioned in a center of a camera screen of the detection image sensor.

12. The system of claim 11, wherein the detection image sensor that detects the UAV is configured to:
transmit a call signal to call the classification image sensor; and
transmit, when a response is received from at least one classification image sensor positioned within a predetermined distance, the PT of the detection image sensor, the position information indicating a position where the detection image sensor is installed, and the distance information indicating a distance between the detection image sensor and the UAV to a classification image sensor that first transmit the response.

13. The system of claim 6, wherein the classification image sensor is configured to acquire the magnified image of the UAV by setting a parameter of a camera of the classification image sensor according to the position information and the distance information.

14. The system of claim 13, wherein the classification image sensor is configured to:
determine an angle parameter of the camera of the classification image sensor according to the position information, and control an angle of the camera of the classification image sensor according to the angle parameter;
determine a magnification parameter of the camera of the classification image sensor according to the distance information, and control a zoom of the camera of the classification image sensor according to the magnification parameter; and
shoot the magnified image of the UAV by using the camera of the classification image sensor whose angle and zoom are controlled.

15. The system of claim 6, wherein the classification image sensor is configured to, when the type of the UAV is unable be classified by analyzing the magnified image, re-shoot a magnified image by correcting a parameter of a camera of the classification image sensor, and classify the type of the UAV by analyzing the re-shot magnified image.
